(19) United States
(12) Patent Application Publication
(10) Pub. No.: US 2026/0071637 A1
(43) Pub. Date: Mar. 12, 2026

(54) HYDRAULIC CYLINDER

(71) Applicant: SMC CORPORATION, Tokyo (JP)

(72) Inventor: Akihiro KAZAMA, Tsukubamirai-shi (JP)

(73) Assignee: SMC CORPORATION, Tokyo (JP)

(21) Appl. No.: 19/105,912

(22) PCT Filed: Sep. 2, 2022
(86) PCT No.: PCT/JP2022/033114

§ 371 Date: Feb. 24, 2025

(51) Int. Cl. F15B 15/14; F15B 15/28

(52) U.S. Cl. CPC F15B 15/1428; F15B 15/1447; F15B 15/1457; F15B 15/2815

(57) ABSTRACT

A hydraulic cylinder includes a cylinder housing having an accommodation chamber, and a cylinder unit. The cylinder housing has a first securing portion. The cylinder unit has a piston, a piston rod with which the piston is provided, a sleeve for accommodating the piston and a second securing portion. The cylinder unit is accommodated in the accommodation chamber. The cylinder unit can be detachably attached to the cylinder housing due to engagement of the first securing portion with the second securing portion.

### TECHNICAL FIELD

The present invention relates to a fluid pressure cylinder (hydraulic cylinder) which operates based on supply and discharge of a pressure fluid.

### BACKGROUND ART

As described in JP 2019-113101 A, an air cylinder includes a cylinder tube in which a piston chamber is formed, and a piston accommodated in the piston chamber. A supply/discharge tube for supplying and discharging compressed air to and from the piston chamber is connected to the air cylinder. In some cases, a position sensor for detecting the position of the piston is provided in the cylinder tube. Further, a seal member (packing) is mounted on a side peripheral wall (outer peripheral portion) of the piston. The seal member seals a gap between a side peripheral wall of the piston and an inner peripheral wall of the piston chamber.

The piston moves in the piston chamber based on supply and discharge of compressed air to and from the piston chamber. Accordingly, the seal member is brought into sliding contact with the side peripheral wall of the piston. Therefore, when the operation of the air cylinder is repeated, the seal member becomes worn. That is, the seal member is a consumable part. The air cylinder includes various types of consumable parts in addition to the seal part. Therefore, the air cylinder requires periodic maintenance.

The air cylinder is assembled to a predetermined apparatus, for example. Therefore, when a maintenance work is performed on the air cylinder, the air cylinder needs to be removed from the predetermined apparatus. Next, the supply/discharge pipe is removed from the air cylinder. If the position sensor is attached to the air cylinder, the position sensor is then removed from the air cylinder. Next, the air cylinder is disassembled and the consumable parts are replaced.

The air cylinder is then assembled and the position sensor is then attached to the air cylinder. Next, the supply/discharge tube is attached to the air cylinder. Next, the air cylinder is assembled to the predetermined apparatus, and the mounting position of the position sensor is adjusted. That is, for example, the piston is shifted to a predetermined position, and the position sensor is disposed at a position where the piston in this state can be detected. The maintenance work is completed through the above operation sequence.

### SUMMARY OF THE INVENTION

As can be understood from the above, the maintenance work of the air cylinder includes many work processes. Therefore, it is not easy to perform the maintenance work on the air cylinder. Further, while the maintenance work is being performed on the air cylinder, operation of the apparatus to which the air cylinder should be assembled must be stopped. Therefore, the operation efficiency of the apparatus is reduced.

After the air cylinder has been assembled, the piston is accommodated in the cylinder tube. Therefore, the operator cannot visually recognize the piston. Under such circumstances, it is not easy to align the piston and the position sensor.

An object of the present invention is to solve the above-described problems.

An aspect of the present invention is characterized by a fluid pressure cylinder including: a cylinder housing in which an accommodation chamber is formed; and a cylinder unit configured to be insertably and removably accommodated in the accommodation chamber, wherein the cylinder housing includes: a first fixing member; and a position sensor, wherein the cylinder unit includes: a piston configured to be pushed by a pressure fluid; a piston rod provided with the piston; a sleeve in which a piston chamber in which the piston slides is formed; a first holder configured to hold one end portion of the sleeve; a second holder configured to hold another end portion of the sleeve; and a second fixing member configured to be engaged with the first fixing member, and wherein an insertion hole into which the piston rod is inserted is formed in at least one of the first holder or the second holder, and by engaging the first fixing member with the second fixing member, the cylinder unit is attachably and detachably coupled to the cylinder housing and the position sensor is aligned with the piston.

The fluid pressure cylinder having the above configuration includes the cylinder unit in which the piston, the piston rod, and the like are integrally assembled. The cylinder unit is insertably and removably accommodated in the accommodation chamber of the cylinder housing. Therefore, in the case that it comes time for the maintenance work of the cylinder unit, for example, the cylinder unit is replaced with a spare unit. This makes it possible to operate the fluid pressure cylinder again.

As can be understood from this, in the present invention, when the cylinder unit is replaced with a spare unit, it is not particularly necessary to remove the cylinder housing from facilities or equipment. That is, the cylinder unit can be replaced with a spare unit while the cylinder housing is fixed to the facilities or the equipment. Further, it is not particularly necessary to remove the position sensor and the wiring connected to the position sensor from the cylinder housing.

Thus, according to the present invention, for example, by replacing the cylinder unit with a spare unit, the maintenance work of the fluid pressure cylinder can be completed. In this case, the maintenance work is only to replace the cylinder unit with a spare unit. For the reasons described above, the number of maintenance work steps is reduced. Further, the maintenance work is simplified. That is, the maintenance work can be performed on the fluid pressure cylinder easily and in a short time. Therefore, the operation down-time of the facilities or the equipment is shortened.

Moreover, the cylinder unit and the cylinder housing are coupled to each other by the engagement between the first fixing member and the second fixing member. Therefore, the cylinder unit and the cylinder housing can be easily coupled to each other. Further, the coupling of the cylinder unit and the cylinder housing can be released by releasing the engagement between the first fixing member and the second fixing member. Thus, according to the above-described configuration, the cylinder unit can be easily attached to and detached from the cylinder housing.

In addition, the mounting position of the position sensor with respect to the cylinder housing remains unchanged before and after the cylinder unit is removed from the cylinder housing. Therefore, by the cylinder unit being inserted into the cylinder housing and attached thereto, the piston is positioned at a predetermined specified position and is aligned with the position sensor. That is, the piston and the position sensor are aligned with each other. Thus, the piston and the position sensor can be easily aligned with each other even under a situation where the operator cannot visually recognize the piston.

### BRIEF DESCRIPTION OF DRAWINGS

FIG. 1 is a schematic overall perspective view of an air cylinder according to an embodiment of the present invention;

FIG. 2 is a schematic overall perspective view of the air cylinder as viewed from a direction different from that in FIG. 1;

FIG. 3 is an exploded perspective view of the air cylinder;

FIG. 4 is a side sectional view taken along the axial direction of the air cylinder;

FIG. 5 is a plan view of the air cylinder as viewed from Z2 direction;

FIG. 6 is an exploded perspective view of a piston, a first holder, and a cover member when they are removed from a piston rod; and

FIG. 7 is a side sectional view showing a state in which the piston has moved from the state shown in FIG. 4.

### DETAILED DESCRIPTION OF THE INVENTION

Hereinafter, an air cylinder will be described as an example of a fluid pressure cylinder. The pressure fluid is therefore compressed air. The fluid pressure cylinder may be a hydraulic cylinder. In this case, the pressure fluid is hydraulic oil. Further, the air cylinder illustrated in the drawings is a single-rod cylinder, but may be a double-rod cylinder.

The X direction shown in the drawings is the axial direction of an air cylinder, a cylinder housing, or a sleeve.

The X1 direction and the X2 direction along the X direction are opposite to each other. The Y direction shown in the drawings is a horizontal direction orthogonal to the X direction. The Y1 direction and the Y2 direction along the Y direction are opposite to each other. The Z direction shown in the drawings is a vertical direction orthogonal to the X direction and the Y direction. The Z1 direction and the Z2 direction along the Z direction are opposite to each other.

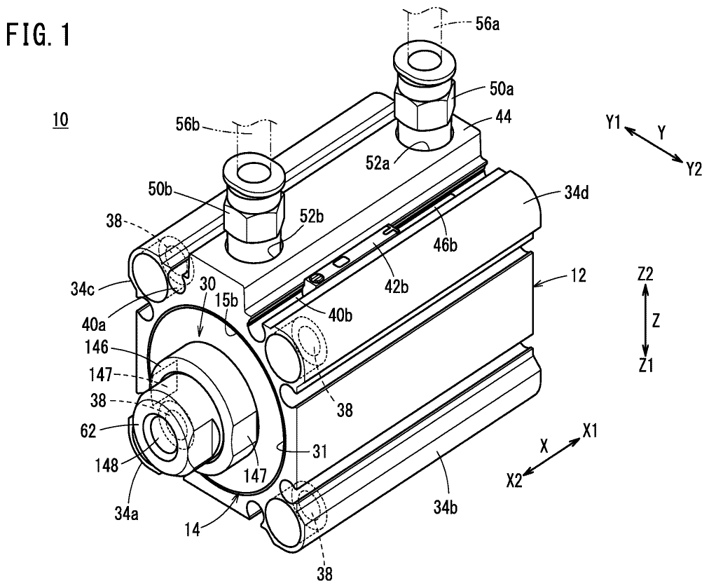

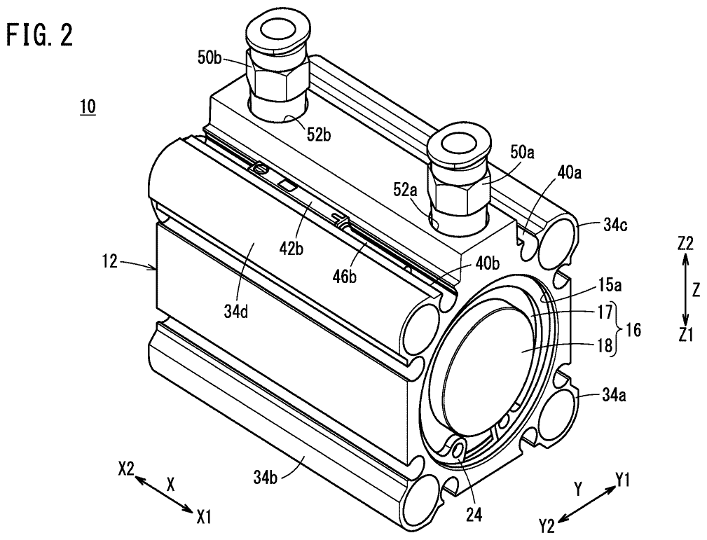

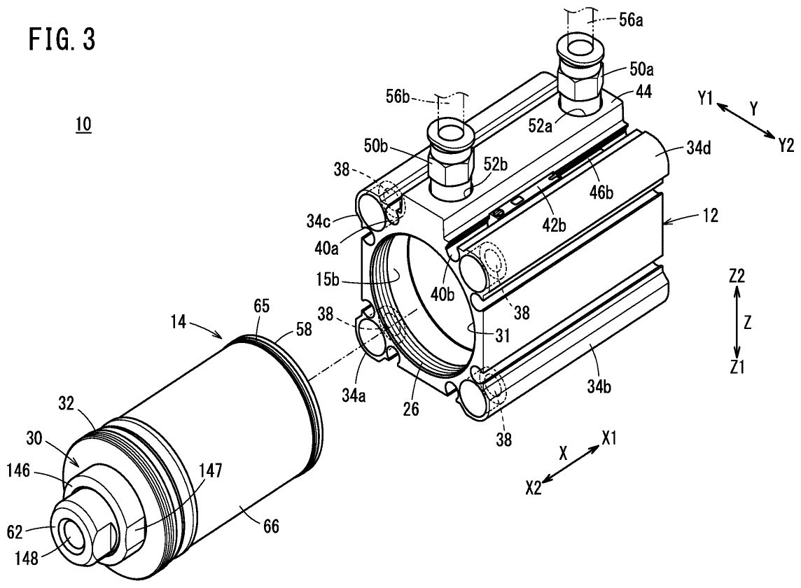

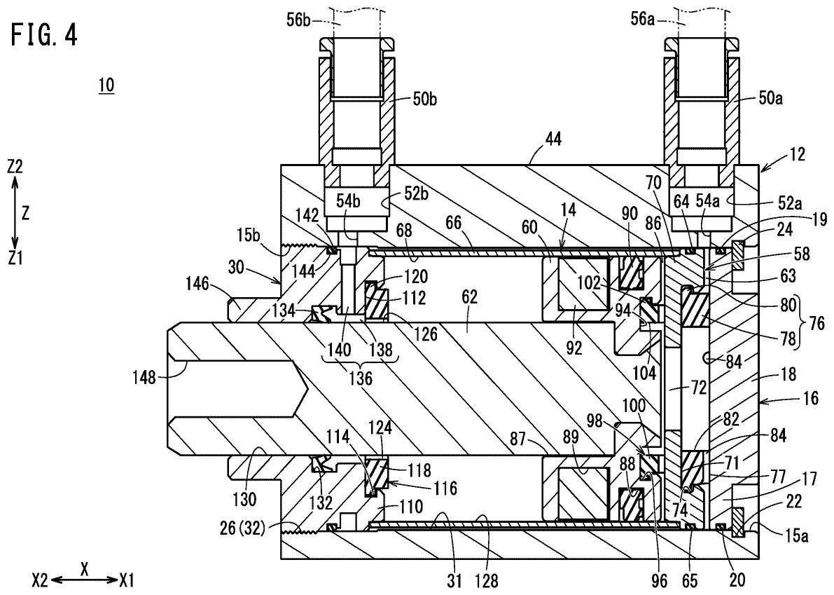

FIG. 1 is a schematic overall perspective view of an air cylinder 10 according to the present embodiment. FIG. 2 is a schematic overall perspective view of the air cylinder 10 as viewed from a direction different from that in FIG. 1. FIG. 3 is an exploded perspective view of the air cylinder 10. FIG. 4 is a side sectional view taken along the axial direction of the air cylinder 10. As shown in FIGS. 1 to 4, the air cylinder 10 includes a cylinder housing 12 and a cylinder unit 14.

First, the cylinder housing 12 will be described. As shown in FIGS. 1 to 3, the cylinder housing 12 has a substantially rectangular tubular shape. As shown in FIG. 4, both end portions of the cylinder housing 12 in the X direction are open ends. A cover member 16 is provided as a closing portion at a first opening 15a which is an opening on the X1 side of the cylinder housing 12. That is, the first opening 15a of the cylinder housing 12 is closed by the cover member 16. As shown in FIGS. 2 and 4, the cover member 16 includes a large-diameter disk portion 17 and a small-diameter cylinder portion 18. The cylinder portion 18 protrudes from an X1 side end surface of the disk portion 17.

In the cover member 16, a first side groove 19 is formed in a side peripheral wall of the disk portion 17 (see FIG. 4). An annular outer seal member 20 is received in the first side groove 19. The outer seal member 20 seals a gap between the side peripheral wall of the disk portion 17 and an inner peripheral wall of the cylinder housing 12 in an airtight manner. On the other hand, a second side groove 22 is formed in the inner peripheral wall of the cylinder housing 12 in the vicinity of the first opening 15a. A snap ring 24, through which the cylinder portion 18 passes, is received in the second side groove 22. The snap ring 24 prevents the cover member 16 from coming off from the cylinder housing 12. In this way, the cover member 16 is positioned and fixed to the cylinder housing 12.

Instead of the snap ring 24, a C-shaped snap wire may be used. In this case, an annular groove (not shown) is formed in the side peripheral wall of the disk portion 17 at a position facing the second side groove 22. The snap wire is inserted into the second side groove 22 and the annular groove, and thereby the cover member 16 is prevented from coming off from the cylinder housing 12.

A first threaded portion 26 is provided on an inner peripheral wall of the cylinder housing 12. More specifically, the first threaded portion 26 is formed at a second opening 15b which is an X2-side opening of the cylinder housing 12. The cylinder unit 14 includes a second holder 30 described later. A second threaded portion 32 is provided on an outer peripheral wall of an X2-side end portion of the second holder 30. The second threaded portion 32 is screw-engaged with the first threaded portion 26, whereby the second opening 15b of the cylinder housing 12 is closed by the second holder 30. As a result of this closing, a space surrounded by the X2-side end surface of the disk portion 17 of the cover member 16, an X1-side end surface of the second holder 30, and the inner peripheral wall of the cylinder housing 12 is formed inside the cylinder housing 12. This space is an accommodation chamber 31 in which the cylinder unit 14 is housed.

As shown in FIGS. 1 to 3, a first protruding portion 34a and a second protruding portion 34b are provided respectively at a Y1-side end portion and a Y2-side end portion, on the Z1 side, of the cylinder housing 12. A third protruding portion 34c and a fourth protruding portion 34d are provided respectively at a Y1-side end portion and a Y2-side end portion, on the Z2 side, of the cylinder housing 12. The first to fourth protruding portions 34a to 34d extend along the axial direction (X direction) at the corners of the cylinder housing 12. The first to fourth protruding portions 34a to 34d are each provided with an elongated hole 38. For example, a long bolt (not shown) for attaching the air cylinder 10 to a predetermined device or apparatus is inserted into the elongated hole 38.

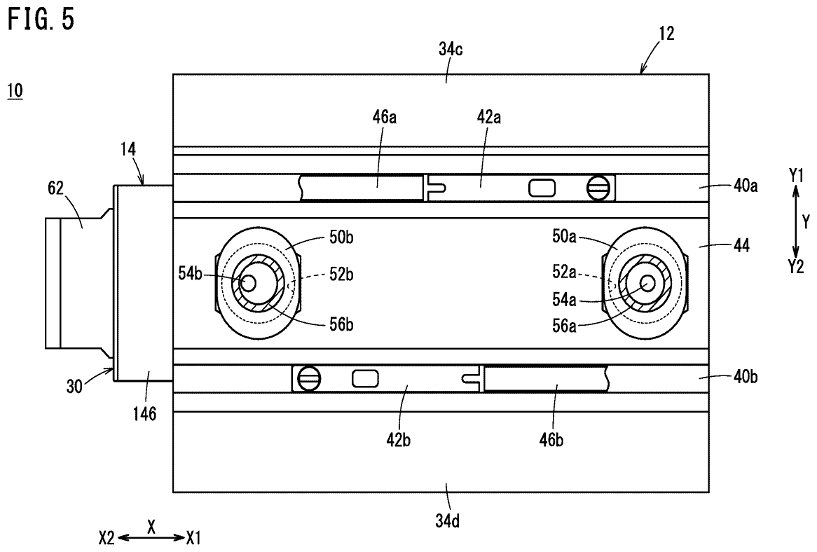

As shown in FIG. 5, in the Z2-side end portion of the cylinder housing 12, a first sensor mounting groove 40a is formed in the vicinity of the third protruding portion 34c, and a second sensor mounting groove 40b is formed in the vicinity of the fourth protruding portion 34d. A first position sensor 42a is mounted in the first sensor mounting groove 40a, and a second position sensor 42b is mounted in the second sensor mounting groove 40b. The first position sensor 42a and the second position sensor 42b are entirely accommodated in the first sensor mounting groove 40a and the second sensor mounting groove 40b, respectively. The first position sensor 42a and the second position sensor 42b are electrically connected to a control unit (not shown) via cables 46a and 46b, respectively.

A first attachment hole 52a for attaching a first tube fitting 50a and a second attachment hole 52b for attaching a second tube fitting 50b are formed in a flat portion 44 of the cylinder housing 12. As shown in FIGS. 4 and 5, a first input/output port 54a is formed in a bottom portion of the first attachment hole 52a. A second input/output port 54b is formed in a bottom portion of the second attachment hole 52b. Compressed air is supplied to and discharged from the cylinder unit 14 via the first input/output port 54a and the second input/output port 54b.

The tip of a first supply/discharge tube 56a is connected to the first tube fitting 50a, and the tip of a second supply/discharge tube 56b is connected to the second tube fitting 50b. The other ends (not shown) of the first supply/discharge tube 56a and the second supply/discharge tube 56b are connected to a supply/discharge mechanism (not shown). Compressed air flows through the first supply/discharge tube 56a and the second supply/discharge tube 56b.

Next, the cylinder unit 14 will be described. As shown in FIG. 4, the cylinder unit 14 is an assembly including a first holder 58, a piston 60, a piston rod 62, the second holder 30,

The sleeve 66 is a cylindrical body, and the piston 60 slides inside the sleeve 66. That is, the inner space of the sleeve 66 is a piston chamber 68.

The first holder 58 holds an X-side end portion (one end portion) of the sleeve 66. When the cylinder unit 14 is inserted into the accommodation chamber 31, the first holder 58 is positioned between the disk portion 17 of the cover member 16 and the piston 60. The disk portion 17 and the first holder 58 are slightly separated from each other. That is, a first annular clearance 63 is formed between the disk portion 17 and the first holder 58. The first annular clearance 63 is in communication with the first input/output port 54a.

An outer annular groove 64 is formed in an outer peripheral wall of the first holder 58. An annular first unit seal 65 is received in the outer annular groove 64. The first unit seal 65 seals a gap between the inner peripheral wall of the cylinder housing 12 and the outer peripheral wall of the first holder 58 in an airtight manner. The first input/output port 54a is positioned between the outer seal member 20 and the first unit seal 65 in the X direction.

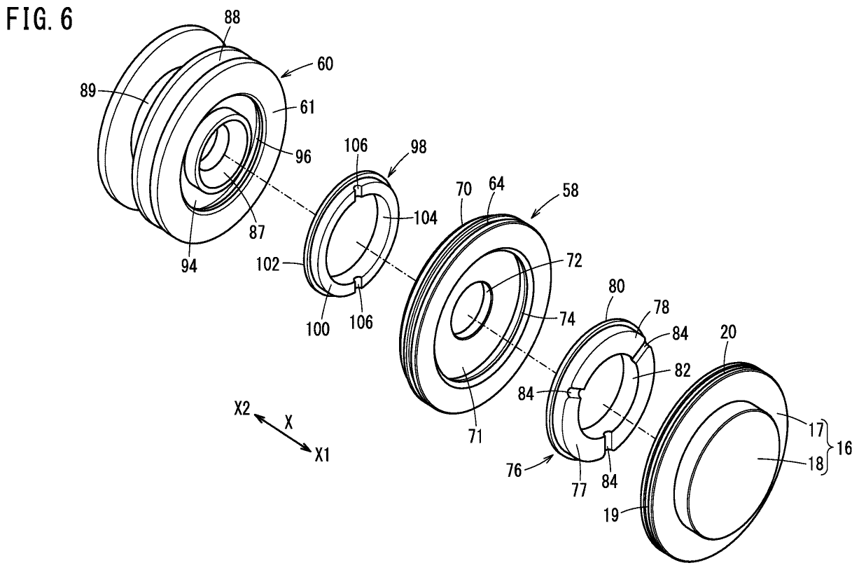

The first holder 58 has a first engagement end 70 projecting toward the piston 60. The first engagement end 70 is inserted into one end portion (X1-side end portion) of the sleeve 66. As shown in FIG. 6, an accommodation recess 71 is formed in an X1-side end surface of the first holder 58 and is recessed toward the first engagement end 70. A passage hole 72 is formed in the first holder 58 so as to penetrate the first holder 58 in the X direction. An annular insertion groove 74 recessed radially outward is formed in a radially outer edge portion of a bottom portion of the accommodation recess 71.

A holder-side damper 76, which is an annular elastic member, is accommodated in the accommodation recess 71. The holder-side damper 76 includes a first main body portion 78 and an annular first flange portion 80. The first flange portion 80 is inserted into the insertion groove 74. This insertion prevents the holder-side damper 76 from coming off the accommodation recess 71. The X1-side end portion of the first main body portion 78 is slightly protruded from the accommodation recess 71.

The holder-side damper 76 has a guide hole 82 overlapping the passage hole 72. The guide hole 82 is a hollow portion of the holder-side damper 76. Three guide channels 84 are formed in the first main body portion 78. The guide channels 84 each extend from the outer peripheral wall of the first main body portion 78 toward the inner peripheral wall along the diameter direction of the holder-side damper 76. An outer peripheral opening of each guide channel 84 communicates with the first annular clearance 63, and an inner peripheral opening of each guide channel 84 communicates with the guide hole 82. In this way, the first annular clearance 63 and the guide hole 82 communicate with each other via the guide channels 84. The guide channels 84 are grooves formed in an end surface 77 (the end surface that abuts against the disk portion 17) of the holder-side damper 76.

A first chamber 86 is formed by the X2-side end surface of the first holder 58, an X1-side end surface 61 of the piston 60 (see FIG. 6), and the inner peripheral wall of the sleeve 66. The first chamber 86 is a space on one side of the piston by the piston 60.

The piston 60 has a fitting hole 87, a packing mounting groove 88, and a magnet mounting groove 89 (see FIG. 6). The X1-side end portion of the piston rod 62 is fitted into the fitting hole 87 (see FIG. 4). A packing 90 and a magnet 92 are received in the packing mounting groove 88 and the magnet mounting groove 89, respectively. The annular packing 90 seals a gap between the outer peripheral wall of the piston 60 and the inner peripheral wall of the sleeve 66 in an airtight manner.

As shown in FIG. 6, a mounting recess 94 is formed in the X1-side end surface 61 of the piston 60. An annular holding groove 96 recessed radially outward is formed in a radially outer edge portion of a bottom portion of the mounting recess 94. A first damper 98 is accommodated in the mounting recess 94. The first damper 98 includes a second main body portion 100 and an annular second flange portion 102. The second flange portion 102 is inserted into the holding groove 96. This insertion prevents the first damper 98 from coming off from the mounting recess 94. The X1-side end portion of the second main body portion 100 is slightly protruded from the mounting recess 94. That is, the X1-side end portion of the first damper 98 protrudes toward the first holder 58 beyond the X1-side end surface 61 (the end surface facing the first holder 58) of the piston 60.

The first damper 98 has an inlet/outlet hole 104 as a hollow portion and two inlet/outlet channels 106. The two inlet/outlet channels 106 are formed in the second main body portion 100. The inlet/outlet hole 104 faces the passage hole 72. The inlet/outlet channels 106 each extend from the outer peripheral wall of the second main body portion 100 toward the inner peripheral wall thereof along the diameter direction of the first damper 98. The inlet/outlet channels 106 guide the compressed air that has flowed into the inlet/outlet hole 104, to the first chamber 86 that is positioned radially outward of the inlet/outlet hole 104. The inlet/outlet channels 106 are grooves formed in an X1-side end surface of the first damper 98.

The second holder 30 holds the X2-side end portion (the other end portion) of the sleeve 66. As shown in FIG. 4, the second holder 30 has a second engagement end 110 that protrudes toward the piston 60. The second engagement end 110 is inserted into the other end portion (X2-side end portion) of the sleeve 66. The second holder 30 is formed with an engagement recess 112. An annular engagement groove 114 recessed radially outward is formed in a radially outer edge portion of a bottom portion of the engagement recess 112. A second damper 116 is accommodated in the engagement recess 112. The second damper 116 includes a third main body portion 118 and a third flange portion 120. The third flange portion 120 is inserted into the engagement groove 114. By this insertion, the second damper 116 is prevented from coming off from the engagement recess 112. The X1-side end portion of the third main body portion 118 is slightly protruded from the engagement recess 112. That is, the X1-side end portion of the second damper 116 protrudes toward the piston 60 beyond the X1-side end surface (the end surface facing the piston 60) of the second holder 30.

The second damper 116 has a supply/discharge hole 124. The diameter of the supply/discharge hole 124 is larger than the diameter of the piston rod 62. That is, a second annular clearance 126 is formed between the side peripheral wall of the piston rod 62 and the inner peripheral wall of the supply/discharge hole 124.

A second chamber 128 is formed by the X2-side end surface of the piston 60, the X1-side end surface of the second holder 30, and the inner peripheral wall of the sleeve 66. The second chamber 128 is a space on the other side of the piston chamber 68 partitioned by the piston 60.

The second holder 30 is formed with an insertion hole 130 through which the piston rod 62 is inserted. An inner groove 132 is formed in an inner peripheral wall of the insertion hole 130. An annular rod seal 134 is received in the inner groove 132. The rod seal 134 seals a gap between the side peripheral wall of the piston rod 62 and the inner peripheral wall of the insertion hole 130 in an airtight manner.

In the second holder 30, a flow passage 136 is formed between the engagement recess 112 and the inner groove 132. The flow passage 136 includes a first passage 138 extending in the axial direction (X direction) of the second holder 30 and a second passage 140 extending in the radial direction (Z direction) of the second holder 30. The X1-side end of the first passage 138 communicates with the second annular clearance 126. The X2-side end of the first passage 138 is closed by the rod seal 134. The Z1-side end of the second passage 140 communicates with the first passage 138. The Z2-side end of the second passage 140 communicates with the second input/output port 54b. That is, the second annular clearance 126 communicates with the second input/output port 54b via the flow passage 136.

An annular outer groove 142 is formed in the outer peripheral wall of the second holder 30 at a position shifted in the X2 direction from the second passage 140. An annular second unit seal 144 is received in the outer groove 142. The second unit seal 144 seals a gap between the outer peripheral wall of the second holder 30 and the inner peripheral wall of the accommodation chamber 31 in an airtight manner. That is, the first unit seal 65 and the second unit seal 144 prevent the compressed air in the piston chamber 68 from leaking into the accommodation chamber 31.

The second threaded portion 32 is formed at the X2-side end portion of the outer peripheral wall of the second holder 30. As described above, the second threaded portion 32 is screw-engaged with the first threaded portion 26 formed at the X2-side end portion of the cylinder housing 12. Further, an operation portion 146 protruding in the X2 direction is provided on the X2-side end surface of the second holder 30. The operation portion 146 is a portion to be clamped by a tool such as a wrench, a spanner, or pliers. Two flat surfaces 147 are formed on the outer peripheral wall of the operation portion 146 at positions that are line-symmetrical to each other with respect to the central axis of the second holder 30 (see FIG. 1).

The positions of the first threaded portion 26 and the second threaded portion 32 are not particularly limited to the above-described positions. For example, the first threaded portion 26 may be provided on the first opening 15a, and the second threaded portion 32 may be provided on the outer peripheral wall of the disk portion 17 of the cover member 16. Alternatively, the first threaded portion 26 may be provided on the inner peripheral wall of the accommodation chamber 31, and the second threaded portion 32 may be provided on the outer peripheral wall of the sleeve 66.

The piston rod 62 is inserted into the insertion hole 130 of the second holder 30. The piston 60 is mounted on the X1-side end portion of the piston rod 62. A coupling hole 148 is formed in the X2-side end portion of the piston rod 62. A part of a workpiece (not shown) is inserted into the coupling hole 148. Therefore, when the piston 60 is displaced in the sleeve 66, the piston rod 62 and the workpiece are displaced integrally with the piston 60. The workpiece is, for example, a predetermined jig.

The first engagement end 70 of the first holder 58 is press-fitted into one end portion (X1-side opening) of the sleeve 66. The outer peripheral wall of the first engagement end 70 is in close contact with the inner peripheral wall of the one end portion of the sleeve 66 over the entire circumference of the first engagement end 70. The second engagement end 110 of the second holder 30 is press-fitted into the other end portion (X2-side opening) of the sleeve 66. The outer peripheral wall of the second engagement end 110 is in close contact with the inner peripheral wall of the other end portion of the sleeve 66 over the entire circumference of the second engagement end 110. By the above-described press-fitting, the X1-side opening of the sleeve 66 is closed by the first holder 58, and the X2-side opening of the sleeve 66 is closed by the second holder 30. The first holder 58 and the second holder 30 can be manually removed from the sleeve 66.

The air cylinder 10 according to the present embodiment is basically configured as described above. Next, the operations and advantageous effects of the air cylinder 10 will be described.

A workpiece is connected to the piston rod 62. More specifically, a part of the workpiece is inserted into the coupling hole 148 of the piston rod 62. The air cylinder 10 operates in this state.

FIG. 4 shows a state in which the compressed air in the first chamber 86 has been discharged, while the compressed air has been supplied to the second chamber 128. In this case, since the internal pressure of the second chamber 128 is higher than the internal pressure of the first chamber 86, the piston 60 is moved in the X1 direction by receiving the pressure from the compressed air in the second chamber 128, and is positioned at the first position closest to the disk portion 17 of the cover member 16. For moving the piston 60 in the X2 direction from this state, the compressed air is supplied to the first chamber 86, and the compressed air is discharged from the second chamber 128. More specifically, the compressed air is sent from the supply/discharge mechanism to the first supply/discharge tube 56a. The compressed air flows into the first input/output port 54a after flowing through the first supply/discharge tube 56a. The compressed air passes through the first input/output port 54a and flows into the first annular clearance 63 between the disk portion 17 and the first holder 58.

The compressed air flows from the first annular clearance 63 to the guide channels 84 of the holder-side damper 76, and then flows from the guide channels 84 to the guide hole 82 of the holder-side damper 76. The compressed air further flows from the guide hole 82 to the passage hole 72 of the first holder 58. In other words, the compressed air in the first annular clearance 63 reaches the passage hole 72 via the guide channels 84 and the guide hole 82.

The passage hole 72 faces the inlet/outlet hole 104 of the first damper 98. Therefore, the compressed air moves from the passage hole 72 to the inlet/outlet hole 104. Here, the two inlet/outlet channels 106 are formed in the second main body portion 100 of the first damper 98. The inlet/outlet channels 106 extend along the diameter direction of the second main body portion 100. Therefore, the compressed air in the inlet/outlet hole 104 flows into the first chamber 86 located radially outward of the first damper 98 through the inlet/outlet channels 106. As a result, the internal pressure of the first chamber 86 increases, and the piston 60 starts to move in the X2 direction. Thus, the guide channels 84 are formed in the holder-side damper 76, and as a result, a path for the compressed air from the first annular clearance 63 to the first chamber 86 is formed. That is, a path for the compressed air for pressing the piston 60 can be provided.

As understood from the above, according to the present embodiment, even when the first damper 98 is in abutment against the first holder 58, the compressed air enters the first chamber 86 through the inlet/outlet hole 104. Therefore, not only the compressed air in the inlet/outlet hole 104 pushes the piston 60, but also the compressed air in the first chamber 86 pushes the piston 60. As a result, the area of the piston 60 that receives pressure from the compressed air increases. In other words, the piston 60 is sufficiently subjected to the pressure of the compressed air. When the piston 60 starts to move in the X2 direction and the first damper 98 separates from the first holder 58, the compressed air flows directly into the first chamber 86 from the passage hole 72 of the first holder 58.

On the other hand, the compressed air in the second chamber 128 is discharged by the supply/discharge mechanism. More specifically, the compressed air in the second chamber 128 passes through the second annular clearance 126 formed by the supply/discharge hole 124 of the second damper 116, and flows into the first passage 138 of the flow passage 136. The compressed air moves from the first passage 138 to the second passage 140, and further flows into the second supply/discharge tube 56b via the second input/output port 54b. Thus, the compressed air in the second chamber 128 is discharged through the second supply/discharge tube 56b. As a result, the internal pressure of the second chamber 128 decreases.

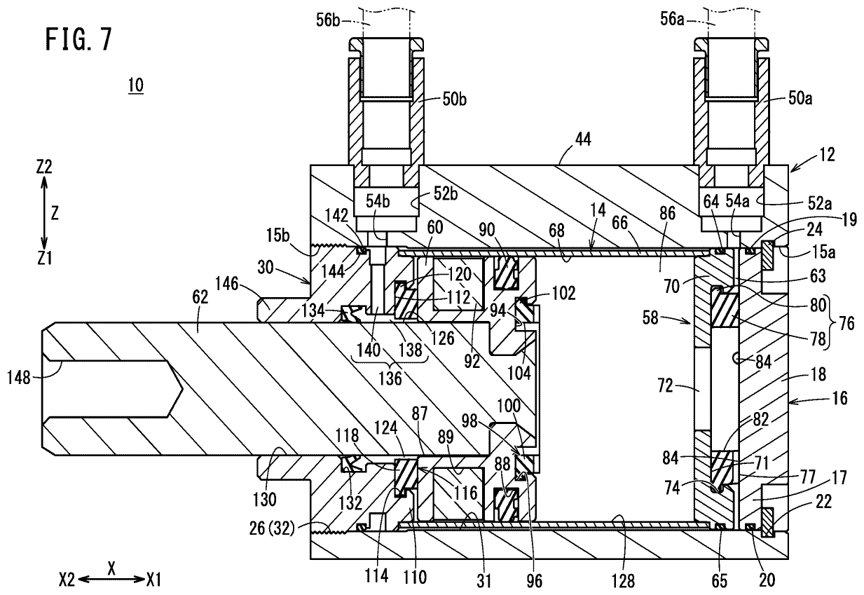

As the internal pressure difference is generated between the first chamber 86 and the second chamber 128 as described above, the piston 60 receives a pressure from the compressed air in the first chamber 86. As a result, the piston 60 slides. That is, the piston 60 moves toward the second holder 30 located at the X2-side end portion. As a result, the air cylinder 10 is brought into a state shown in FIG. 7. In FIG. 7, the piston 60 is located at a second position. Thus, the workpiece coupled to the piston rod 62 is moved, for example. The second position sensor 42b detects the magnetic force of the magnet 92, and based on this detection, it is detected that the piston 60 has reached the second position. The control unit receives the detection signal from the second position sensor 42b and recognizes that the piston 60 has moved to the second position.

The X2-side end surface of the piston 60 abuts against, for example, the third main body portion 118 of the second damper 116. This reduces the impact transmitted from the piston 60 to the second holder 30.

In order to return the piston 60 to the state shown in FIG. 4, compressed air is sent out from the supply/discharge mechanism to the second chamber 128, and compressed air is discharged from the first chamber 86 by the supply/discharge mechanism. The compressed air in the first chamber 86 passes through the inlet/outlet channels 106, the inlet/outlet hole 104, the passage hole 72, the guide hole 82, the guide channels 84, the first annular clearance 63, and the first input/output port 54a in this order, and flows into the first supply/discharge tube 56a. Thus, the compressed air in the first chamber 86 is discharged through the first supply/discharge tube 56a, and the internal pressure of the first chamber 86 decreases.

The compressed air sent from the supply/discharge mechanism flows through the second supply/discharge tube 56b, subsequently passes through the second input/output port 54b, the second passage 140, the first passage 138, and the second annular clearance 126 in this order, and then flow into the second chamber 128. As a result, the internal pressure of the second chamber 128 increases. As described above, the piston 60 slides in accordance with the internal pressure difference between the first chamber 86 and the second chamber 128. That is, the piston 60 moves toward the disk portion 17 of the cover member 16 positioned at the X1-side end portion and reaches the first position. As a result, the air cylinder 10 returns to the state shown in FIG. 4. At this time also, the workpiece connected to the piston rod 62 is moved, for example. The first position sensor 42a detects the magnetic force of the magnet 92, and based on this detection, it is detected that the piston 60 has reached the first position. The control unit receives the detection signal from the first position sensor 42a and recognizes that the piston 60 has moved to the first position.

When the piston 60 moves, the first damper 98 provided in the mounting recess 94 of the piston 60 abuts against the X2-side end surface of the first engagement end 70 of the first holder 58. Thus, the impact transmitted from the piston 60 to the first holder 58 is damped. If the first holder 58 is pushed out in the X1 direction, the holder-side damper 76 provided in the accommodation recess 71 of the first holder 58 abuts against the X2-side end surface of the disk portion 17 of the cover member 16. This reduces the impact transmitted from the first holder 58 to the cover member 16.

When the piston 60 repeats the above movement, the packing 90 mounted on the outer peripheral wall of the piston 60 repeatedly slides on while in contact with the inner peripheral wall of the sleeve 66. Further, the rod seal 134 provided in the second holder 30 repeatedly slides on while in contact with the piston rod 62. The packing 90 and the rod seal 134 wear due to the sliding contact described above. When the packing 90 and the rod seal 134 are excessively worn, the compressed air leaks between the first chamber 86 and the second chamber 128, and thus it is difficult to move the piston 60. In order to avoid this, the packing 90 and the rod seal 134 are replaced with new ones.

Therefore, a worker who performs a maintenance work detaches the cylinder unit 14 from the cylinder housing 12. More specifically, the worker clamps the operation portion 146 of the second holder 30 with a tool such as a wrench, a spanner, or pliers. In this state, the worker turns the tool, whereby the second threaded portion 32 rotates relative to the first threaded portion 26. As a result, the second threaded portion 32 and the first threaded portion 26 are disengaged from each other. That is, the cylinder unit 14 is released from constraint of the cylinder housing 12.

Next, the worker pulls the operation portion 146 and the like in the X2 direction as shown in FIG. 3. Here, the rod seal 134 provided in the second holder 30 is in close contact with the piston rod 62. The second holder 30 holds the second damper 116 and the sleeve 66, holds the first holder 58 via the sleeve 66, and further holds the holder-side damper 76 via the first holder 58. The piston rod 62 holds the piston 60, and the piston 60 holds the first damper 98. Therefore, as the worker pulls the operation portion 146 and the like in the X2 direction, the cylinder unit 14 slides in the X2 direction. As a result, the cylinder unit 14 is pulled out from the accommodation chamber 31 of the cylinder housing 12.

A slight clearance is formed between the inner peripheral wall of the accommodation chamber 31 of the cylinder housing 12 and the outer peripheral wall of the sleeve 66. Therefore, the sleeve 66 is prevented from interfering with the inner peripheral wall of the accommodation chamber 31. Therefore, the worker can easily slide the cylinder unit 14 toward the X2 direction and detach the cylinder unit 14 from the cylinder housing 12.

As described above, according to the present embodiment, the cylinder unit 14 can be separated from the cylinder housing 12 in a state where the first tube fitting 50a, the first supply/discharge tube 56a, the second tube fitting 50b, and the second supply/discharge tube 56b are connected to the cylinder housing 12. Further, it is not necessary to remove the first position sensor 42a and the second position sensor 42b from the cylinder housing 12. It is not necessary to remove the cables 46a and 46b, which electrically connect the first position sensor 42a and the second position sensor 42b to the control unit, from the cylinder housing 12. Furthermore, there is no particular need to remove the cylinder housing 12 from facilities or equipment.

As described above, the first position sensor 42a and the second position sensor 42b are entirely accommodated in the first sensor mounting groove 40a and the second sensor mounting groove 40b, respectively. Therefore, even when the cylinder housing 12 is removed from the facilities or the equipment, the first position sensor 42a and the second position sensor 42b are prevented from interfering with any objects. Therefore, the first position sensor 42a and the second position sensor 42b are prevented from being damaged due to the interference. In other words, the first position sensor 42a and the second position sensor 42b are protected owing to the mounting of the first position sensor 42a in the first sensor mounting groove 40a and the mounting of the second position sensor 42b in the second Sensor mounting groove 40b.

Next, the worker replaces the cylinder unit 14 with a spare unit, for example. More specifically, the worker inserts the spare unit in which the holder-side damper 76, the first holder 58, the second holder 30, the second damper 116, the piston rod 62, the piston 60, and the first damper 98 are integrally assembled, into the accommodation chamber 31 of the cylinder housing 12. At this time, the worker slides the spare unit from the X2 direction toward the X1 direction in a state where the holder-side damper 76 and the first holder 58 are directed toward the X1 direction. Since the sleeve 66 is prevented from interfering with the inner peripheral wall of the accommodation chamber 31, the sliding is also easy.

Next, the worker clamps the operation portion 146 of the second holder 30 with a tool such as a wrench, a spanner, or pliers. The worker turns the tool in this state, whereby the second threaded portion 32 is screw-engaged with the first threaded portion 26. Thus, the cylinder unit 14 is coupled to (constrained by) the cylinder housing 12. In this way, in the present embodiment, the second opening 15b of the cylinder housing 12 serves as a mounting portion for the cylinder unit 14. That is, when mounting the cylinder unit 14 to the cylinder housing 12, there is no need to mount it via any member. Therefore, when the cylinder unit 14 is attached to and detached from the cylinder housing 12, it is not necessary to attach and detach any member.

In the operation of separating the cylinder unit 14 from the cylinder housing 12 and the operation of assembling the spare unit to the cylinder housing 12, the first position sensor 42a and the second position sensor 42b are kept in a state of being attached to the cylinder housing 12. Therefore, after the spare unit is accommodated in the accommodation chamber 31, the first position sensor 42a or the second position sensor 42b becomes aligned with the piston 60. Therefore, it is not particularly necessary to perform the operation of aligning the first position sensor 42a or the second position sensor 42b with the piston 60. Further, it is not particularly necessary to remove the cables 46a and 46b from the first position sensor 42a and the second position sensor 42b. For the above reason, the maintenance work is simplified.

When the spare unit is inserted into the accommodation chamber 31, the first annular clearance 63 is formed between the first holder 58 and the X2-side end surface of the disk portion 17 in the cover member 16. Here, the holder-side damper 76 is held in the accommodation recess 71 of the first holder 58. Here, a part of the holder-side damper 76 protrudes from the accommodation recess 71 toward the disk portion 17. Therefore, a portion of the holder-side damper 76 that protrudes from the accommodation recess 71 abuts against the X2-side end surface of the disk portion 17. As a result, the first holder 58 and the disk portion 17 are slightly separated from each other. This separation certainly forms the first annular clearance 63.

In this embodiment, the first threaded portion 26 and the second threaded portion 32 are screw-engaged with each other. Therefore, the cylinder unit 14 is positioned and fixed relative to the cylinder housing 12. In other words, the cylinder unit 14 is prevented from being misaligned in the axial direction (X direction) of the cylinder housing 12. Therefore, for example, the first holder 58 is prevented from moving to a position that causes the first input/output port 54a to be closed. Further, since the first holder 58 stops at a predetermined position in the X direction, the first annular clearance 63 is reliably formed.

Furthermore, the screw-engagement between the first threaded portion 26 and the second threaded portion 32 prevents the piston rod 62 from being misaligned in the Z direction. That is, the axial center of the sleeve 66 (the axial center of the piston chamber 68), the axial center of the insertion hole 130, the axial center of the piston rod 62, and the axial center of the piston 60 coincide with each other with high accuracy. Therefore, for example, a situation in which the axial center of the piston rod 62 is inclined with respect to the axial center of the insertion hole 130 and the piston 60 is inclined with respect to the axial center of the piston chamber 68 is avoided. Therefore, by coupling the workpiece to the coupling hole 148, the center alignment between the workpiece and the piston rod 62 can be performed. Thus, the workpiece can be attached to the piston rod 62 in a predetermined posture. In this state, the workpiece moves integrally with the piston rod 62 as the piston rod 62 moves. That is, the workpiece can be moved along a predetermined movement trajectory set in advance.

Thereafter, the user operates the air cylinder 10 assembled by using the spare unit. In this case as well, the air cylinder 10 operates in the same manner as described above. As described above, according to the present embodiment, the maintenance work of the air cylinder 10 can be completed by replacing the cylinder unit 14 with a spare unit. That is, by using the spare unit, the maintenance work of the air cylinder 10 can be easily performed in a short time. Therefore, the operation down-time of predetermined facilities or predetermined equipment in which the air cylinder 10 is incorporated can be shortened.

Further, according to the present embodiment, when a maintenance work is performed on the cylinder unit 14, it is not necessary to remove the first tube fitting 50a, the first supply/discharge tube 56a, the second tube fitting 50b, the second supply/discharge tube 56b, the first position sensor 42a, the second position sensor 42b, the cables 46a, 46b, and the like from the cylinder housing 12. Therefore, the number of work processes for the maintenance work is reduced. In addition, the maintenance work is simplified. That is, the maintenance work can be easily performed on the air cylinder 10.

It is also possible to perform a maintenance work on the cylinder unit 14 removed from the cylinder housing 12. In this case, the worker disassembles the cylinder unit 14. For example, the worker detaches the second engagement end 110 of the second holder 30 from the sleeve 66. As a result, the second holder 30, the piston rod 62, and the piston 60 are pulled out from the sleeve 66. The worker pulls out the piston rod 62 from the insertion hole 130. Thus, the second holder 30 is detached from the piston rod 62. Further, the worker separates the second damper 116 from the engagement recess 112.

As a result, the packing 90 and the rod seal 134 are in a replaceable state. The worker replaces the packing 90 and the rod seal 134 with new ones. The worker replaces the second damper 116, the second unit seal 144, or the first damper 98 with a new one, as necessary. Further, the holder-side damper 76 and the first unit seal 65 can be replaced with new ones. The worker then assembles the cylinder unit 14 in a procedure reverse to the above. When it comes time to perform the maintenance work on the spare unit, the worker replaces the spare unit with a cylinder unit 14 on which the maintenance has been completed, in the same manner as described above.

As described above, the present embodiment discloses the fluid pressure cylinder including: the cylinder housing (12) in which the accommodation chamber (31) is formed; and the cylinder unit (14) configured to be insertably and removably accommodated in the accommodation chamber, wherein the cylinder housing includes: the first fixing member; and the position sensor (42a, 42b), wherein the cylinder unit includes: the piston (60) configured to be pushed by the pressure fluid; the piston rod (62) provided with the piston; the sleeve (66) in which the piston chamber (68) in which the piston slides is formed; the first holder (58) configured to hold one end portion of the sleeve; the second holder (30) configured to hold another end portion of the sleeve; and the second fixing member configured to be engaged with the first fixing member, and wherein the insertion hole (130) into which the piston rod is inserted is formed in at least one of the first holder or the second holder, and by engaging the first fixing member with the second fixing member, the cylinder unit is attachably and detachably coupled to the cylinder housing and the position sensor is aligned with the piston.

The fluid pressure cylinder includes a cylinder unit in which a piston, a piston rod, and the like are integrally assembled. The cylinder unit is insertably and removably accommodated in the accommodation chamber of the cylinder housing. Therefore, in the case that it comes time for the maintenance work of the cylinder unit, for example, the cylinder unit is replaced with a spare unit. This makes it possible to operate the fluid pressure cylinder again.

As can be understood from this, in the present embodiment, when the cylinder unit is replaced with a spare unit, it is not particularly necessary to remove the cylinder housing from facilities or equipment. Further, it is not particularly necessary to remove the position sensor and the wiring connected to the position sensor from the cylinder housing. That is, the work for performing a maintenance on the fluid pressure cylinder is typically only to replace the cylinder unit with a spare unit. For the reasons described above, the number of maintenance work steps is reduced. Further, the maintenance work is simplified. That is, according to the present embodiment, the maintenance work can be performed on the fluid pressure cylinder easily and in a short time. Therefore, the operation down-time of the facilities or the equipment is shortened.

Moreover, the cylinder unit and the cylinder housing are coupled to each other by the engagement between the first fixing member and the second fixing member. Therefore, the cylinder unit and the cylinder housing can be easily coupled to each other. Further, the coupling of the cylinder unit and the cylinder housing can be released by releasing the engagement between the first fixing member and the second fixing member. Thus, according to the above-described configuration, the cylinder unit can be easily attached to and detached from the cylinder housing.

In addition, the mounting position of the position sensor with respect to the cylinder housing remains unchanged before and after the cylinder unit is removed from the cylinder housing. Therefore, by the cylinder unit being inserted into the cylinder housing and attached thereto, the piston is positioned at a predetermined specified position and is aligned with the position sensor. That is, the piston and the position sensor are aligned with each other. Thus, the piston and the position sensor can be easily aligned with each other even under a situation where the operator cannot visually recognize the piston.

The present embodiment discloses the fluid pressure cylinder wherein the first fixing member is the first threaded portion (26) formed on the inner peripheral wall of the cylinder housing that defines the accommodation chamber, the second fixing member is the second threaded portion (32) formed on the outer peripheral wall of the cylinder unit, and the first threaded portion is screw-engaged with the second threaded portion.

In this case, the cylinder unit and the cylinder housing are coupled to each other via the first threaded portion and the second threaded portion. Therefore, by rotating the cylinder unit relative to the cylinder housing, the coupling of the cylinder unit and the cylinder housing can be easily released.

Similarly, it is easy to couple the cylinder unit and the cylinder housing. That is, with this configuration, the cylinder unit can be easily attached to and detached from the cylinder housing.

In addition, in this case, the cylinder unit is satisfactorily positioned and fixed with respect to the cylinder housing. Thus, for example, a path for compressed air can be provided reliably. In addition, the piston rod and the piston are prevented from moving in a state of being eccentric with respect to the piston chamber. Therefore, the workpiece can be moved integrally with the piston rod in a state where the workpiece is in a predetermined posture with respect to the piston rod.

The present embodiment discloses the fluid pressure cylinder wherein the passage hole (72) is formed in the first holder, and the pressure fluid flows through the passage hole and reaches the piston.

In this way, by providing the passage hole in the first holder, the pressure fluid can be supplied to the piston accommodated in the sleeve. Alternatively, the pressure fluid pushed by the piston can be discharged to the outside of the sleeve through the passage hole. In other words, the piston can be easily moved owing to the passage hole being provided in the first holder.

The present embodiment discloses the fluid pressure cylinder wherein the cylinder housing includes the closing portion (16) configured to close one end portion of the accommodation chamber in the axial direction of the accommodation chamber, the annular clearance (63) is formed between the first holder and the closing portion, and the pressure fluid that pushes the piston flows into the passage hole from the clearance.

In this case, one end portion, in the axial direction, of the accommodation chamber of the cylinder housing is closed by the closing portion. In this configuration, it is preferable that a clearance communicating with the passage hole is formed between the first holder and the closing portion. With this configuration, the pressure fluid can be supplied to and discharged from the piston accommodated inside the sleeve through the clearance and the passage hole. That is, in this configuration as well, the piston can be easily moved.

The present embodiment discloses the fluid pressure cylinder wherein the annular elastic member (76) is provided between the first holder and the closing portion, and the elastic member includes: the hollow portion as the guide hole (82) that communicates with the piston chamber via the passage hole of the first holder to thereby guide the pressure fluid; and the guide channel (84) that allows the clearance and the hollow portion to communicate with each other.

When the piston moves toward the first holder, the piston may abut against the first holder. In this case, the first holder may be pushed out by the piston and may come into contact with the closing portion. By providing the elastic member on the first holder, the impact when the first holder abuts against the closing portion is damped.

In this case, it is preferable that the guide channel and the guide hole are formed in the elastic member. With this configuration, even when the elastic member abuts against the closing portion, the pressure fluid can be sent from the clearance to the guide hole via the guide channel. The pressure fluid passes through the passage hole of the first holder and comes into contact with the piston. In this way, owing to the guide channel and the guide hole being formed in the elastic member, even in a state where the elastic member abuts on the closing portion, the pressure fluid can be supplied to the piston.

The present embodiment discloses the fluid pressure cylinder wherein the elastic member includes the end surface (77) that abuts against the closing portion, and the guide channel is a groove formed in the end surface.

By forming the guide channel as a groove in the end surface of the elastic member, the guide channel is prevented from being occluded even when the end surface abuts against the closing portion. It is thus possible to send pressure fluid to the passage hole via the guide channel.

The present embodiment discloses the fluid pressure cylinder wherein the first chamber (86) is formed between the piston and the first holder, and the piston includes the annular damper (98) facing the first holder, and the damper includes: the inlet/outlet hole (104) that faces the passage hole in the axial direction of the cylinder unit and through which the pressure fluid flows; and the inlet/outlet channel (106) that allows the inlet/outlet hole and the first chamber to communicate with each other.

As described above, when the piston moves toward the first holder, the piston may come into contact with the first holder. The damper provided on the piston reduces the impact occurring when the piston abuts against the first holder.

In this case, it is preferable that the damper is provided with the inlet/outlet channel and the inlet/outlet hole. With this configuration, even when the damper abuts against the first holder, the pressure fluid that has passed through the passage hole of the first holder can be received by the inlet/outlet hole. Further, the pressure fluid received by the inlet/outlet hole can be sent to the first chamber via the inlet/outlet channel. As a result, the pressure fluid contacts the piston in the inlet/outlet hole and the first chamber.

That is, with this configuration, the pressure fluid comes into contact with the piston in the inlet/outlet hole and the first chamber. In this case, the contact area of the pressure fluid with the piston is larger than in the case where the pressure fluid contacts the piston only at the inlet/outlet hole. Therefore, the piston can be easily moved.

In a specific embodiment, the second holder is formed with the second fixing member and the insertion hole. That is, the present embodiment discloses the fluid pressure cylinder wherein the cylinder housing includes the closing portion (16) configured to close one end portion of the accommodation chamber in the axial direction of the accommodation chamber, and the second holder closes another end portion of the accommodation chamber in the axial direction, and the second holder is provided with the second fixing member and the insertion hole.

In this way, a single-rod cylinder can be configured. Further, since the first threaded portion is positioned at one end portion of the cylinder housing and the second threaded portion is positioned at one end portion of the cylinder unit, it is easy to relatively turn and screw the first threaded portion with respect to the second threaded portion.

The present embodiment discloses the fluid pressure cylinder wherein the second holder includes: the damper (116) configured to abut against the piston; and the flow passage (136) through which the pressure fluid flows, and the damper includes the supply/discharge hole (124) that communicates with the flow passage.

In this case, the pressure fluid can be supplied to or discharged from the piston chamber via the supply/discharge hole and the flow passage. Therefore, it is unnecessary to form the sleeve with a flow path for flowing the pressure fluid.

The present embodiment discloses the fluid pressure cylinder wherein the cylinder housing includes: the first tube fitting (50a) configured to be connected to the first supply/discharge tube (56a) configured to supply and discharge the pressure fluid; the first attachment hole (52a) to which the first tube fitting is attached; the second tube fitting (50b) configured to be connected to the second supply/discharge tube (56b) configured to supply and discharge the pressure fluid; and the second attachment hole (52b) to which the second tube fitting is attached.

In this case, the cylinder unit can be separated from the cylinder housing in a state where the first tube fitting and the second tube fitting are attached to the cylinder housing. When a maintenance is performed on the cylinder unit, it is not necessary to remove the first tube fitting, the first supply/discharge tube, the second tube fitting, the second supply/discharge tube, and the like from the cylinder housing.

Therefore, the maintenance work can be performed more easily on the fluid pressure cylinder.

The present embodiment discloses the fluid pressure cylinder wherein the cylinder housing includes the sensor mounting groove (40a, 40b) in which the position sensor is mounted.

In this case, the position sensor is received in the sensor mounting groove. Therefore, for example, when the maintenance is performed on the fluid pressure cylinder, the position sensor is prevented from interfering with any objects. In other words, the position sensor is protected.

Moreover, it should be noted that the present invention is not limited to the disclosure described above, and various alternative or additional configurations can be adopted therein without departing from the essence and gist of the present invention.

### REFERENCE SIGNS LIST

10: air cylinder
12: cylinder housing
14: cylinder unit
16: cover member
26: first threaded portion
30: second holder
31: accommodation chamber
32: second threaded portion
40a: first sensor mounting groove
40b: second sensor mounting groove
42a: first position sensor
42b: second position sensor
50a: first tube fitting
50b: second tube fitting
52b: second attachment hole
54a: first input/output port
54b: second input/output port
56a: first supply/discharge tube
56b: second supply/discharge tube
58: first holder
60: piston
62: piston rod
63: first annular clearance
65: first unit seal
66: sleeve
68: piston chamber
70: first engagement end
72: passage hole
76: holder-side damper
82: guide hole
84: guide channel
86: first chamber
90: packing
92: magnet
98: first damper
104: inlet/outlet hole
106: inlet/outlet channel
110: second engagement end
116: second damper
124: supply/discharge hole
126: second annular clearance
128: second chamber
130: insertion hole
134: rod seal
136: flow passage
138: first passage
144: second unit seal
146: operation portion

1. A fluid pressure cylinder comprising:
a cylinder housing in which an accommodation chamber is formed; and
a cylinder unit configured to be insertably and removably accommodated in the accommodation chamber,
wherein the cylinder housing includes:
a first fixing member; and
a position sensor,
wherein the cylinder unit includes:
a piston configured to be pushed by a pressure fluid;
a piston rod provided with the piston;
a sleeve in which a piston chamber in which the piston slides is formed;
a first holder configured to hold one end portion of the sleeve;
a second holder configured to hold another end portion of the sleeve; and
a second fixing member configured to be engaged with the first fixing member, and
wherein an insertion hole into which the piston rod is inserted is formed in at least one of the first holder or the second holder, and by engaging the first fixing member with the second fixing member, the cylinder unit is attachably and detachably coupled to the cylinder housing and the position sensor is aligned with the piston.

2. The fluid pressure cylinder according to claim 1, wherein the first fixing member is a first threaded portion formed on an inner peripheral wall of the cylinder housing that defines the accommodation chamber, the second fixing member is a second threaded portion formed on an outer peripheral wall of the cylinder unit, and the first threaded portion is screw-engaged with the second threaded portion.

3. The fluid pressure cylinder according to claim 1, wherein a passage hole is formed in the first holder, and the pressure fluid flows through the passage hole and reaches the piston.

4. The fluid pressure cylinder according to claim 3, wherein the cylinder housing includes a closing portion configured to close one end portion of the accommodation chamber in an axial direction of the accommodation chamber,
an annular clearance is formed between the first holder and the closing portion, and
the pressure fluid that pushes the piston flows into the passage hole from the clearance.

5. The fluid pressure cylinder according to claim 4, wherein an annular elastic member is provided between the first holder and the closing portion, and
the elastic member includes:
a hollow portion as a guide hole that communicates with the piston chamber via the passage hole of the first holder to thereby guide the pressure fluid; and
a guide channel that allows the clearance and the hollow portion to communicate with each other.

6. The fluid pressure cylinder according to claim 5, wherein the elastic member includes an end surface configured to abut against the closing portion, and the guide channel is a groove formed in the end surface.

7. The fluid pressure cylinder according to claim 3, wherein a first chamber is formed between the piston and the first holder, and the piston includes an annular damper facing the first holder, and
the damper includes:
an inlet/outlet hole that faces the passage hole in an axial direction of the cylinder unit and through which the pressure fluid flows; and
an inlet/outlet channel that allows the inlet/outlet hole and the first chamber to communicate with each other.

8. The fluid pressure cylinder according to claim 1, wherein the cylinder housing includes a closing portion configured to close one end portion of the accommodation chamber in an axial direction of the accommodation chamber, and
the second holder closes another end portion of the accommodation chamber in the axial direction, and the second holder is provided with the second fixing member and the insertion hole.

9. The fluid pressure cylinder according to claim 8, wherein the second holder includes:
a damper configured to abut against the piston; and
a flow passage through which the pressure fluid flows, and
the damper includes a supply/discharge hole that communicates with the flow passage.

10. The fluid pressure cylinder according to claim 1, wherein the cylinder housing includes:
a first tube fitting configured to be connected to a first supply/discharge tube configured to supply and discharge the pressure fluid;
a first attachment hole to which the first tube fitting is attached;
a second tube fitting configured to be connected to a second supply/discharge tube configured to supply and discharge the pressure fluid; and
a second attachment hole to which the second tube fitting is attached.

11. The fluid pressure cylinder according to claim 1, wherein the cylinder housing includes a sensor mounting groove in which the position sensor is mounted.
